(19) United States
(12) Patent Application Publication
(10) Pub. No.: US 2008/0020812 A1
(43) Pub. Date: Jan. 24, 2008

(54) Collapsible Mobile Radio Device

(75) Inventors: Hiroaki Kobayashi, Kanagawa (JP); Masashi Koshi, Ishikawa (JP); Kenichi Yamada, Kanagawa (JP); Yutaka Saito, Ishikawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/720,137

(22) PCT Filed: Nov. 25, 2005
(86) PCT No.: PCT/JP05/21709

§ 371 Date: May 24, 2007

(30) Foreign Application Priority Data
Nov. 26, 2004 (JP) 2004-342418

(51) Int. Cl. H04M 1/00

(52) U.S. Cl. 455/575.3

(57) ABSTRACT

A conductive metal frame and a first hinge portion fitted onto an upper case are connected electrically, first and second hinge portions are joined to turn on a rotating shaft, and the first and second hinge portions and the rotating shaft are formed of a conductive metal and conducted electrically via respective contact points. The second hinge portion as the feeding portion is connected to a matching circuit on a circuit board, and one end of a conductive metal element having a predetermined length is connected to the second hinge portion to have an electrical conduction thereto and the other end of the conductive metal element is opened. The conductive metal element is arranged in parallel with a direction orthogonal with a longitudinal direction of a lower case, and is arranged near a surface on the opposite side to the surface on which the operation keys are arranged.

### TECHNICAL FIELD

The present invention relates to a folding type portable radio equipment capable of maintaining a high antenna performance in a speaking condition.

### BACKGROUND ART

The spread of the cellular phone is notable recently. In particular, the folding cellular phone in which the upper and lower cases are joined by the hinge portion to open/close becomes widespread. This folding cellular phone has normally two operation modes of an opened mode and a closed mode. Thus, this folding cellular phone has two advantages, a convenience that a display screen to be looked can be widened when the phone is used in an opened state (opened mode) and an easy-carry quality that the cellular phone can be folded up-into a compact form when the phone is used in a closed state (closed mode).

Further, a reduction in thickness is required of the folding cellular phone nowadays. However, when a thickness of the folding cellular phone is reduced, there is a problem such that the antenna performance is degraded because the antenna comes closer to the user. In addition, when the folding cellular phone is reduced in thickness in this manner, there is another problem such that it is difficult to reduce a local means SAR (Specific Absorption Rate).

As the method of suppressing the local means SAR low in the prior art, the method of connecting (grounding) the conductive metal element, one end of which is opened to a ground near a feeding point, and setting this element to a length to resonate at a desired frequency in the unbalanced feed antenna, for example, is known. This element is arranged normally on the case surface on the opposite side to the case surface on which an opening portion for an earpiece portion positioned close to a human body is provided. According to this configuration, a current from the feeding point flows into the conductive metal element and thus a current flowing through the case surface positioned close to the human body can be reduced (see Patent Literature 1, for example).

As the method of dividing a current from another feeding point, the method of connecting a rod antenna (antenna 2) to the feeding portion in the structure, in which a shield case of the upper case having the earpiece portion is used as an antenna element (antenna 1) and then a current is fed from a ground substrate of the lower case to the antenna element via a flexible cable, in the folding cellular phone is known (see Patent Literature 2, for example).

Patent Literature 1: JP-A-2002-353719

Patent Literature 2: JP-A-2002-335180

### DISCLOSURE OF THE INVENTION

Problems that the Invention is to Solve

However, in the method of reducing the above local mean SAR, such a problem existed that the antenna performance is degraded when the conductive metal element comes close to the user's hand.

Further, in the method of dividing the current from the feeding point, it is difficult to build the antenna in the case because the rod antenna must be projected to the outside of the case. Further, such a problem existed that a high antenna gain cannot be attained because the radiation characteristic cannot be optimized to a speaking condition.

The present invention has been made in view of the above circumstances, and it is an object of the present invention to provide a folding type portable radio equipment capable of improving an antenna performance in a speaking condition by connecting a conductive metal element to a feeding point in a built-in antenna of a folding type portable radio set.

Means for Solving the Problems

A folding type portable radio equipment of the present invention, includes a first case and a second case; an antenna element provided to the first case; a hinge portion for joining turnably the first case and the second case; a circuit board provided in the second case and having a ground pattern thereon; a feeding portion connected to a radio circuit on the circuit board; and a conductive metal element arranged on the hinge portion and having a predetermined length; wherein the hinge portion has a first hinge portion and a second hinge portion formed of a conductive metal, and a joining portion for connecting electrically the first hinge portion and the second hinge portion and supporting turnably the first hinge portion and the second hinge portion, the first hinge portion is provided to the first case and connected electrically to an end portion of the antenna element on a hinge portion side, and the second hinge portion is provided to the second case and is arranged at a predetermined interval from a ground pattern on the circuit board and connected electrically to the feeding portion, the conductive metal element is arranged to intersect orthogonally with a longitudinal direction of the second case such that one end is connected electrically to the second hinge portion and other end is opened, and the antenna element, and the hinge portion and the ground pattern on the circuit board are constructed to operate as a dipole antenna.

According to this configuration, the antenna current can be distributed in the antenna built in the thin case and also the polarization can be optimized to the speaking condition. As a result, the local mean SAR can be reduced and also the high antenna gain can be ensured.

In the folding type portable radio equipment according to the present invention, the conductive metal element resonates at a particular frequency.

According to this configuration, the antenna current can be distributed at a desired frequency in the speaking condition and also the polarization can be optimized to the speaking condition. As a result, the local mean SAR can be reduced and also the high antenna gain can be ensured.

Further, in the folding type portable radio equipment according to the present invention, the conductive metal element has a structure that resonates at two particular frequencies or more.

According to this configuration, one conductive metal element can handle two particular frequencies or more. As a result, the number of articles can be reduced.

Further, in the folding type portable radio equipment according to the present invention, the conductive metal element is printed on the circuit board provided in the second case.

According to this configuration, the conductive metal element to distribute the antenna current can be neglected and the number of articles can be reduced. Further, a space used to mount the conductive metal element is not needed.

Further, in the folding type portable radio equipment according to the present invention, the conductive metal element is arranged on an opposite surface side to a surface on which operation keys are arranged in the second case.

According to this configuration, the antenna current can be distributed to a position that is away from the human body. As a result, the high antenna performance can be ensured.

### ADVANTAGES OF THE INVENTION

According to the present invention, the antenna current in the thin antenna built in the case can be distributed to a position that is away from the human body, and also a polarization can be optimized to a speaking condition. Therefore, the folding type portable radio equipment capable of reducing a local mean SAR and ensuring a high antenna gain can be provided.

### BRIEF DESCRIPTION OF THE DRAWINGS

FIG. 1 is a configurative view of a folding type portable radio equipment according to a first embodiment of the present invention.

FIG. 2 is a side view of the folding type portable radio equipment of the same.

FIG. 3 is a perspective view of the folding type portable radio equipment of the same.

FIG. 4 is a configurative view showing a variation of the folding type portable radio equipment according to the first embodiment.

FIG. 5 is a principle view explaining an operation of the folding type portable radio equipment of the same.

FIG. 6 is an explanatory view showing a speaking condition of the folding type portable radio equipment of the same.

FIG. 7 is an explanatory view of an SAR reducing rate in the folding type portable radio equipment of the same.

FIG. 8 is an explanatory view of an SAR reducing rate in the folding type portable radio equipment of the same.

FIG. 9 is a configurative view showing another variation of the folding type portable radio equipment according to the first embodiment.

FIG. 10 is a perspective view of a folding type portable radio equipment according to a second embodiment of the present invention.

FIG. 11 is a perspective view showing a variation of a folding type portable radio equipment according to the second embodiment.

### DESCRIPTION OF REFERENCE NUMERALS AND SIGNS

1 upper case (first case)
1A metal frame
12 opening portion for an earpiece portion
11 display portion
2 lower case (second case)
21 circuit board
21A feeding terminal
22 matching circuit
23 radio circuit
24 conductive element (printed on a circuit board)
25, 26 conductive metal element
25A, 26A first conductive metal element
25B, 26B second conductive metal element
26C resonance circuit
3 hinge portion
31 first hinge portion
31A, 34A fitting screw
32 second hinge portion
33 rotating shaft
34 feeding metal
35 conductive metal element
36 first coupling element
37 second coupling element
38 first rotating shaft
39 second rotating shaft
H head of a human body
E ear of a human body
α area including the feeding portion
β area including the conductive metal element

### BEST MODE FOR CARRYING OUT THE INVENTION

### First Embodiment

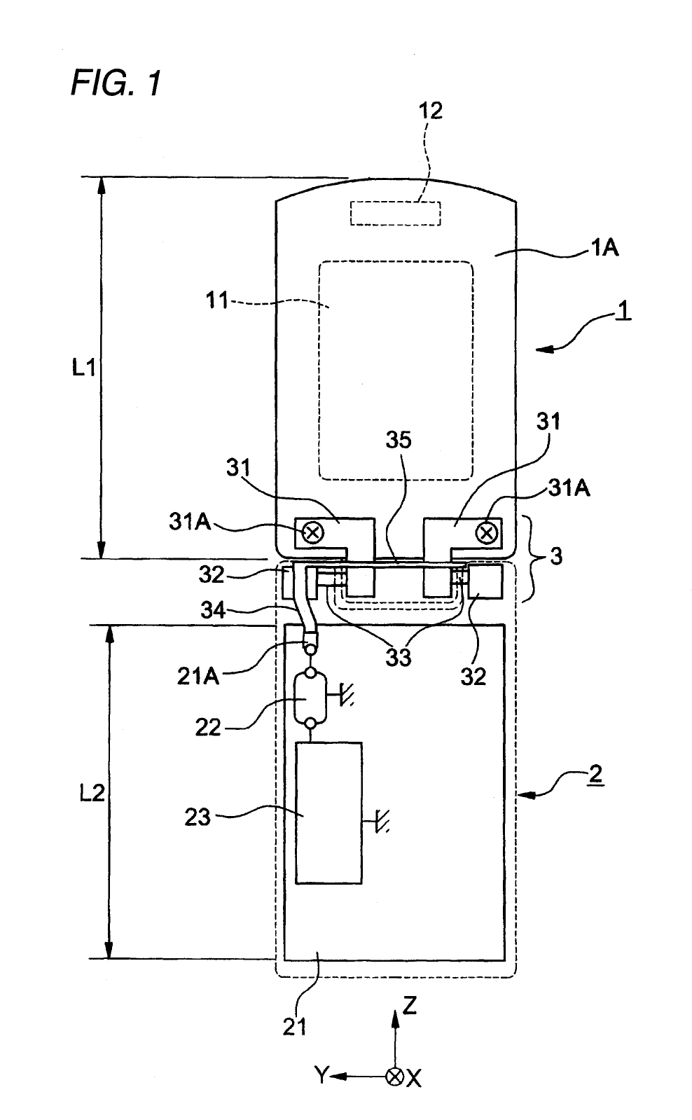

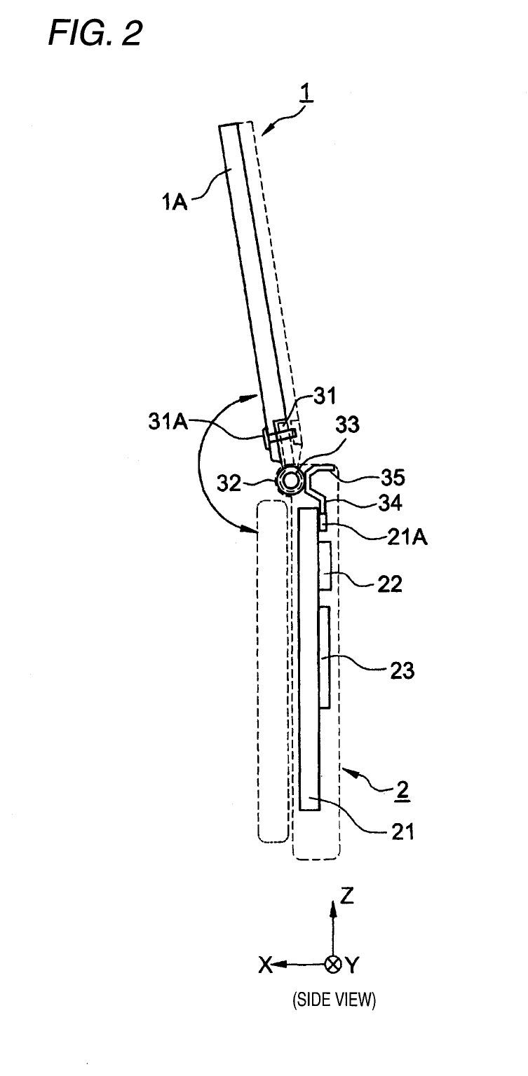

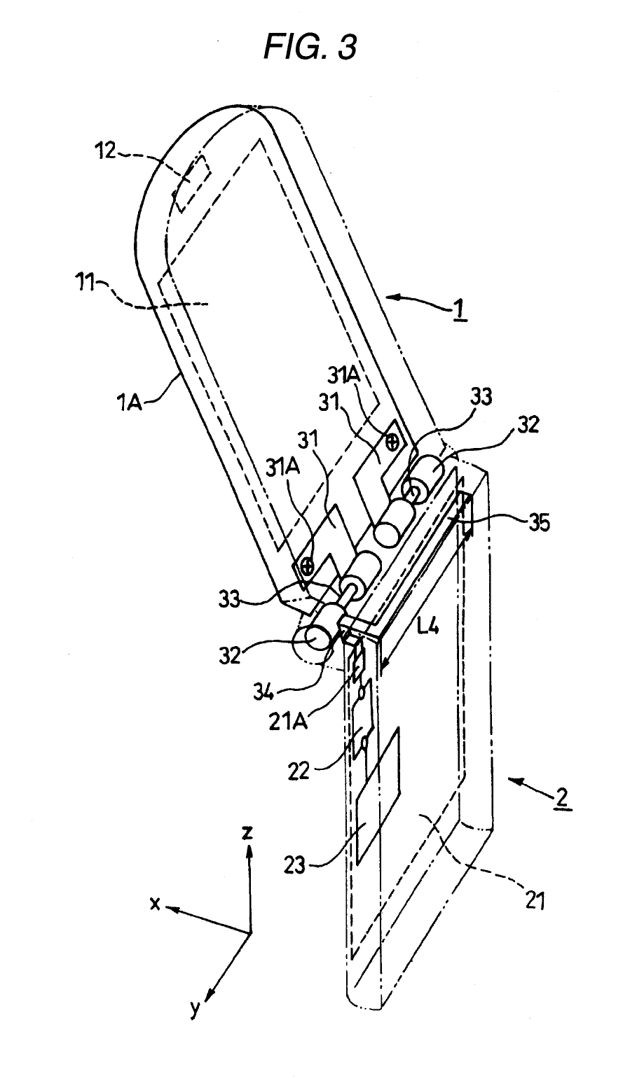

FIG. 1 is a front view of a folding type portable radio equipment according to a first embodiment of the present invention, FIG. 2 is a side view of the folding type portable radio equipment of the same, and FIG. 3 is a perspective view of the folding type portable radio equipment of the same.

As shown in these Figures, the folding type portable radio equipment of the present embodiment has a foldable configuration in which a first case (referred to as an “upper case 1” hereinafter) and a second case (referred to as a “lower case 2” hereinafter) are joined by a hinge portion 3 (one-shaft hinge structure), and can take two operation modes of an opened mode and a closed mode by turning either of the upper case and the lower case 2 around the hinge portion 3.

The upper case 1 has a display portion 11 and an opening portion 12 for an earpiece portion on a surface (inner surface) in the (+) X-axis direction. Further, operation keys (not shown) are arranged on a surface of the lower case 2 in the (+) X-axis direction. In the present embodiment, the upper case 1 and the lower case 2 are formed of a resin material as an insulator.

Further, a surface of the upper case 1 on which the display portion 11 is arranged is constructed by a metal frame 1A that corresponds to an antenna element. Normally a metal such as a magnesium alloy, for example, whose conductivity is high, whose weight is light, and whose strength is high, is employed as this metal frame 1A. A length L1 of a long side is set to about 90 mm, for example.

Further, this metal frame 1A is connected electrically to and fixed mechanically to second hinge portions 32 of the conductive metal element by first hinge portions 31 of the conductive metal element via rotating shafts 33 that are provided to an inside of the hinge portion 3. The first hinge portions 31 are fixed to the metal frame 1A by metal screws 31A provided at two locations along a short side on the hinge portion 3 side, for example, to constitute the hinge portion 3. The second hinge portions 32 similarly constitute the hinge portion 3. Thus, the upper case 1 can be turned. Here, the rotating shafts 33 are formed of a metal, and a contact resistance between the first hinge portions 31 and the second hinge portions 32 is set to 1 Ω or less for example, such that they can be easily conducted electrically.

A feeding terminal 21A is provided to a circuit board 21 arranged in an inside of the lower case 2. A part of the second hinge portions 32 and the feeding terminal 21A are brought physically into contact with each other by a feeding metal 34, for example, and thus they are connected electrically to each other. Further, a contact resistance between the second hinge portions 32 and the feeding metal 34 is set to 1 Ω or less, for example, such that they can be easily conducted electrically. This circuit board 21 is a printed board on which circuit parts for implementing various functions of the portable radio equipment are mounted. A ground pattern whose potential serves as a ground potential of the circuits is formed on an almost overall surface. The feeding terminal 21A is connected to a matching circuit 22 by the soldering, for example, and then the matching circuit 22 is connected to a radio circuit 23.

Further, a conductive metal element 35 is connected to the second hinge portions 32 by the physical contact, for example. This conductive metal element 35 is formed integrally with the feeding metal 34, for example. In the present embodiment, the conductive metal element 35 is arranged near the surface opposing the surface on which the opening portion 12 for the earpiece portion is arranged in the upper case 1, i.e., the surface on the (−) X direction side opposing the surface (X direction) on which normally the operation keys are arranged, for example, in the inside of the lower case 2. Further, this conductive metal element 35 is arranged to intersect orthogonally with a long side (Z direction) of the lower case 2, i.e., arranged in parallel with the Y direction. One end of the conductive metal element 35 is connected electrically to the second hinge portions 32, and the other end is formed as an open end.

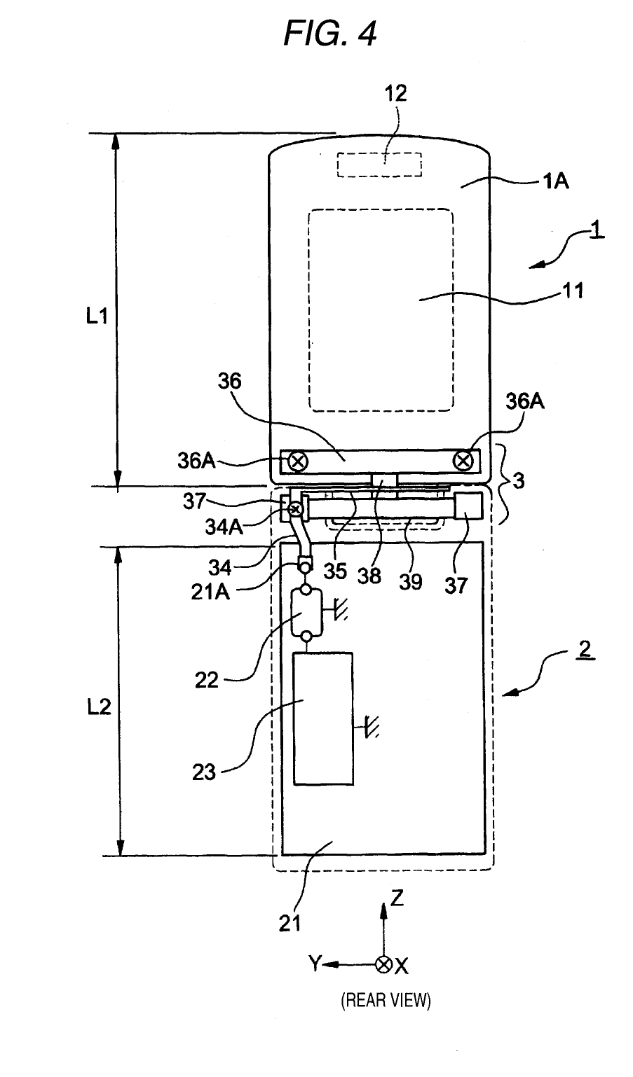

Next, a variation of the first embodiment of the present invention will be explained with reference to FIG. 4 hereunder. In this FIG. 4, the same reference symbols are affixed to the same constituent elements as those in FIG. 1 and their redundant explanations will be avoided herein.

In the folding type portable radio equipment shown in FIG. 4, a structure of the hinge portion 3 is different from that in FIG. 1 (two-shaft hinge structure), but the similar configuration to that in FIG. 1 is employed except this structure. More particularly, as shown in FIG. 4, the hinge portion 3 joins the upper case 1 and the lower case 2 to turn around two shafts in different directions, and is constructed by a first coupling element 36, a second coupling element 37, a first rotating shaft 38, and a second rotating shaft 39, all of which being formed of a conductive metal.

The first coupling element 36 is connected electrically to the metal frame 1A corresponding to the antenna element by fitting screws 36A, for example, and also connected electrically to the first rotating shaft 38. In this case, the first rotating shaft 38 connects the upper case 1 and the lower case 2 so as to allow them to rotate around this first rotating shaft 38.

Further, the second coupling element 37 is connected electrically to the feeding metal 34 by a fitting screw 34A, for example. In this case, the second rotating shaft 39 allows the upper case 1 and the lower case 2 to open/close on this second rotating shaft 39, and also is connected electrically to the first rotating shaft 38. Further, the conductive metal element 35 is connected to the second coupling element 37.

This conductive metal element 35 is formed integrally with the feeding metal 34, for example. This conductive metal element 35 is arranged near the surface (inner surface) opposing the surface on which the opening portion 12 for the earpiece portion is arranged on the upper case 1, i.e., the surface on the (−) X direction side opposing the surface (X direction) on which normally the operation keys are arranged, for example. Further, this conductive metal element 35 is arranged to intersect orthogonally with the long side (Z direction) of the lower case 2, i.e., arranged in parallel with the Y direction. One end of the conductive metal element 35 is connected electrically to the second coupling element 37, and the other end is formed as the open end.

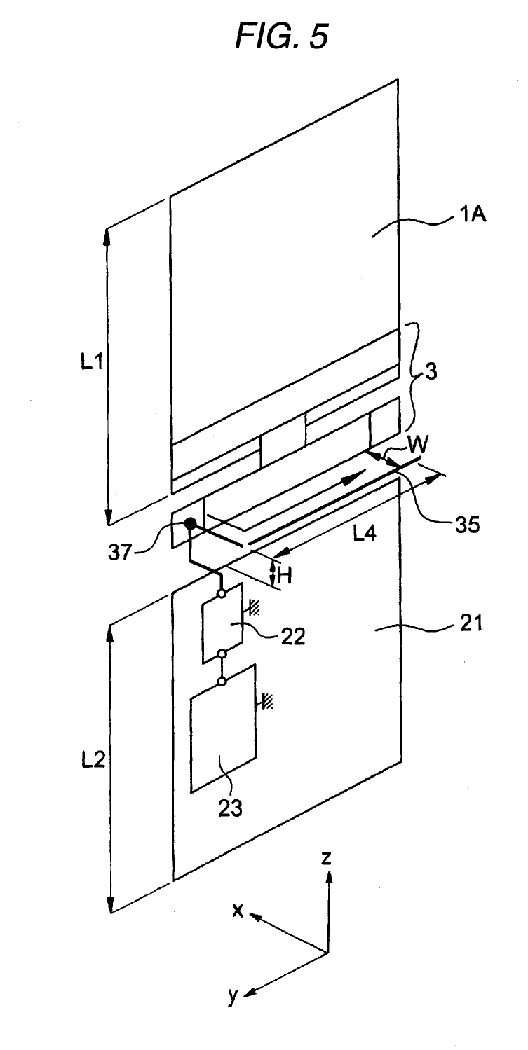

Next, an operational principle of the antenna in the folding type portable radio equipment shown in FIG. 4 will be explained with reference to FIG. 5 hereunder. Here, in order to simplify the explanation, explanation will be made herein based on a simplified model.

In FIG. 5, the metal frame 1A operates as the antenna element whose length is L1 (for example, about 90 mm). The matching circuit 22 fulfills a function of causing an impedance of this antenna element to match with an input impedance (normally 50 Ω) of the radio circuit 23. The ground pattern formed on the circuit board 21 whose length is L2 (for example, 90 mm) operates as a lower antenna element. That is, the metal frame 1A and the circuit board 21 act as a dipole antenna, and thus the high antenna performance can be obtained. At this time, an antenna current converges into the feeding portion.

Further, the conductive metal element 35 is connected electrically to the second coupling element 37 of the hinge portion 3, which serves as the feeding portion of the dipole antenna, perpendicularly to the long side (Z direction) of the circuit board 21, i.e., in parallel with the Y direction. The conductive metal element 35 has an element length L4, and its end portion opposing the connection end to the second coupling element 37 is formed as an open end. Further, a height H of the conductive metal element 35 of the present embodiment from the circuit board 21 is set to about 7 mm and a distance W of the same from the hinge portion 3 is set to 2 mm, for example.

For example, when the length L4 of the conductive metal element 35 is ¼-wave with respect to a wavelength, the antenna current flowing in the arrow direction in FIG. 5 is maximized. Hence, the antenna current being converged into the second coupling element 37 as the feeding portion of the dipole antenna is shunted to the conductive metal element 35.

Normally there is a correlation between a current distribution and the local mean SAR. It is known that, when maximum points of the antenna current converge on one location and this maximum point exists near a human body, the local mean SAR is increased. Therefore, if such antenna current distribution is separated into two locations or more and the maximum point of the antenna current is positioned away from the human body, the local mean SAR can be decreased. This will be explained further in detail with reference to the drawings hereunder.

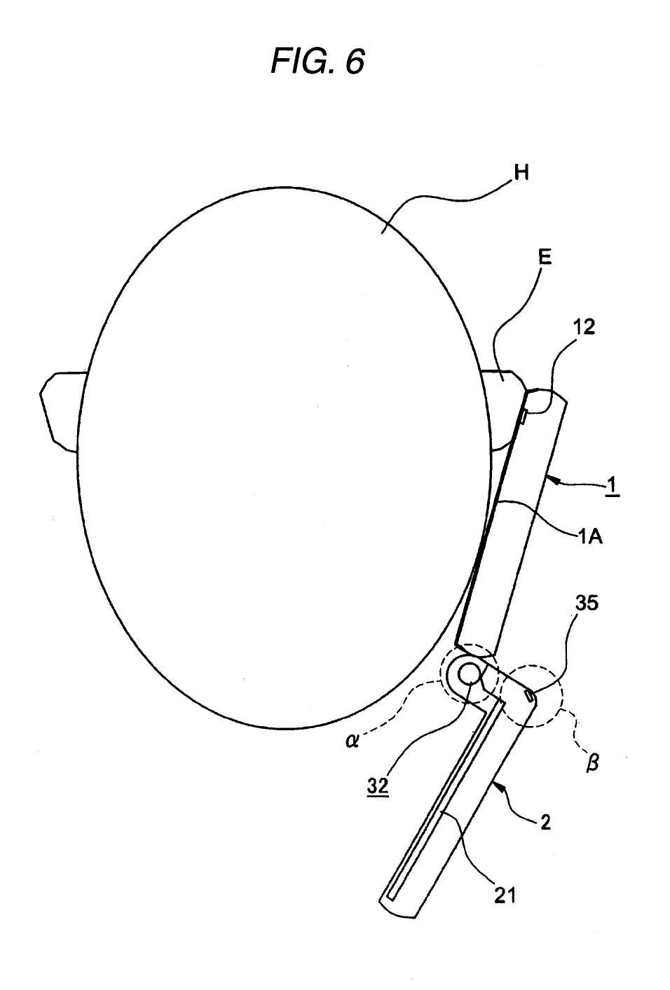

FIG. 6 shows a state that the user is speaking on the folding type portable radio equipment according to the present embodiment, and the same reference symbols are affixed to the same constituent elements as those in FIG. 1. In this case, for the purpose of simplification, an illustration of the user's hand to hold the equipment will be omitted herein.

In FIG. 6, the opening portion 12 for the earpiece portion provided on the upper case 1 is put to user's ear E of the head H of the human body in the speaking condition, and the second hinge portion 32 as the feeding portion of the dipole antenna comes close to the human body (the antenna current converges into an area α). That is, because the area α into which the antenna current converges comes close to the human body, the local mean SAR is increased for the above reason. Particularly the antenna current is apt to converge into the second hinge portion 32 as the feeding portion at 1.92 GHz. However, in the present embodiment, the conductive metal element 35 is connected electrically to the second hinge portion 32. Hence, the antenna current flows through the conductive metal element 35 connected electrically to the second hinge portion 32. As a result, the antenna current is distributed into an area β that is away from the human body.

In other words, it is appreciated that, because the conductive metal element 35 is connected, the antenna current concentration location is distributed to two locations from one location.

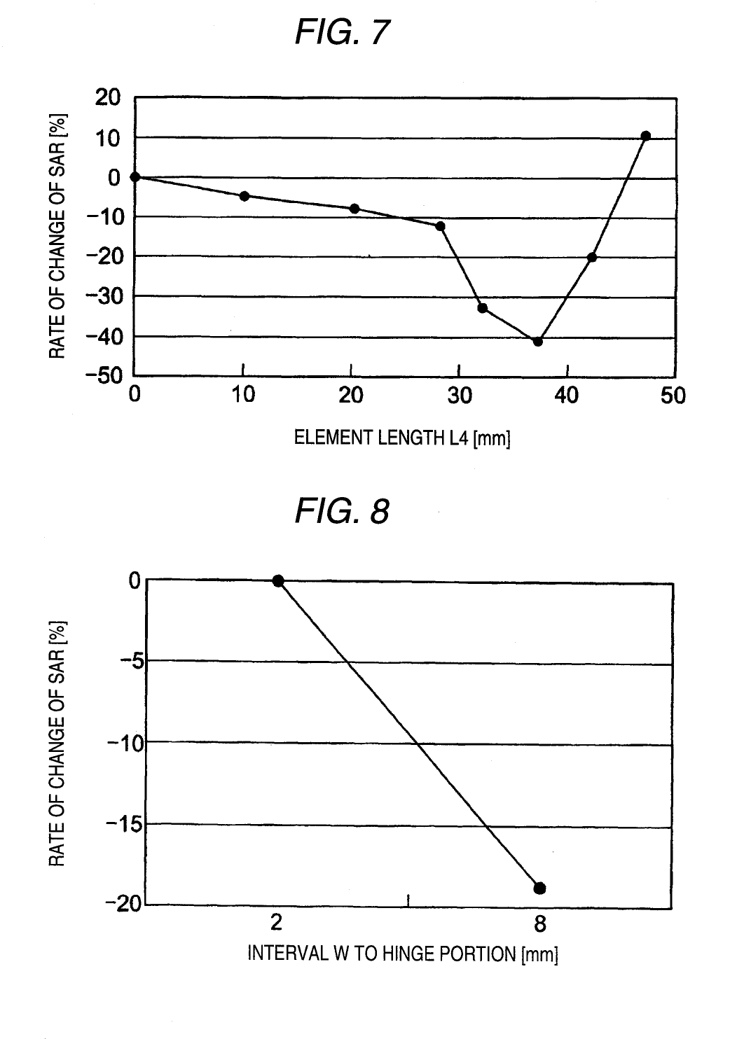

FIG. 7 is a graph showing a rate of change of a local mean SAR over a length L4 of the conductive metal element 35 in FIG. 5. In this case, the interval W between the hinge portion 3 and the conductive metal element 35 is set to 2 mm. Here, suppose that an operating frequency of the antenna is set to 1.92 GHz (a wavelength is about 156 mm).

From this FIG. 7, it can be understood that the local mean SAR can be reduced by connecting the conductive metal element 35 and is changed depending on the element length L4. When the element length L4 of the conductive metal element 35 is set to 37 mm (about ¼ wavelength), the local mean SAR can be reduced by about 40% at a maximum.

Next, FIG. 8 is a view showing a reducing rate of the local mean SAR over an interval W between the conductive metal element 35 and the hinge portion 3 in FIG. 5. In this case, the element length L4 of the conductive metal element 35 is set to 37 mm.

When the interval W is increased by 6 mm (when the interval W is expanded from 2 mm to 8 mm), the local mean SAR is reduced by about 20%. Further, since the conductive metal element 35 into which the antenna current is shunted becomes distant from the human body in the speaking condition, a vertically polarized wave gain in the speaking condition is enhanced and the antenna gain in the speaking condition is improved by 1.0 dB. In this case, even when a height H of the conductive metal element 35 from the circuit board 21 is lowered, the similar reducing effect of the local mean SAR can be achieved.

In this manner, according to the folding type portable radio equipment of the first embodiment of the present invention, the conductive metal element 35 whose length is set to about ¼ wave at a desired frequency is connected electrically to the feeding portion to which the antenna current converges, and is arranged perpendicularly with the long side (Z direction) of the lower case 2, i.e., in parallel with the Y-axis direction. Further, an end portion of the conductive metal element 35 opposing to the end portion that is connected to the feeding portion is formed as an open end. Therefore, the antenna current can be shunted to the conductive metal element 35 and the polarization can be optimized to the speaking condition. As a result, the local mean SAR can be reduced and also the high antenna gain can be ensured.

In the present embodiment, the conductive metal element 35 is constructed integrally with the feeding metal 34. But such a configuration may be employed that the conductive metal element 35 is brought into electrical contact with the feeding metal 34 by a spring force, or the like. Further, even when the conductive metal element 35 is not brought into contact with the feeding metal 34, such conductive metal element 35 may be connected electrically to the conductive element constituting the hinge portion 3 in which the antenna current is concentrated. Further, the conductive metal element 35 may be connected to the feeding metal 34 or the conductive element constituting the hinge portion 3 in terms of a capacitive coupling.

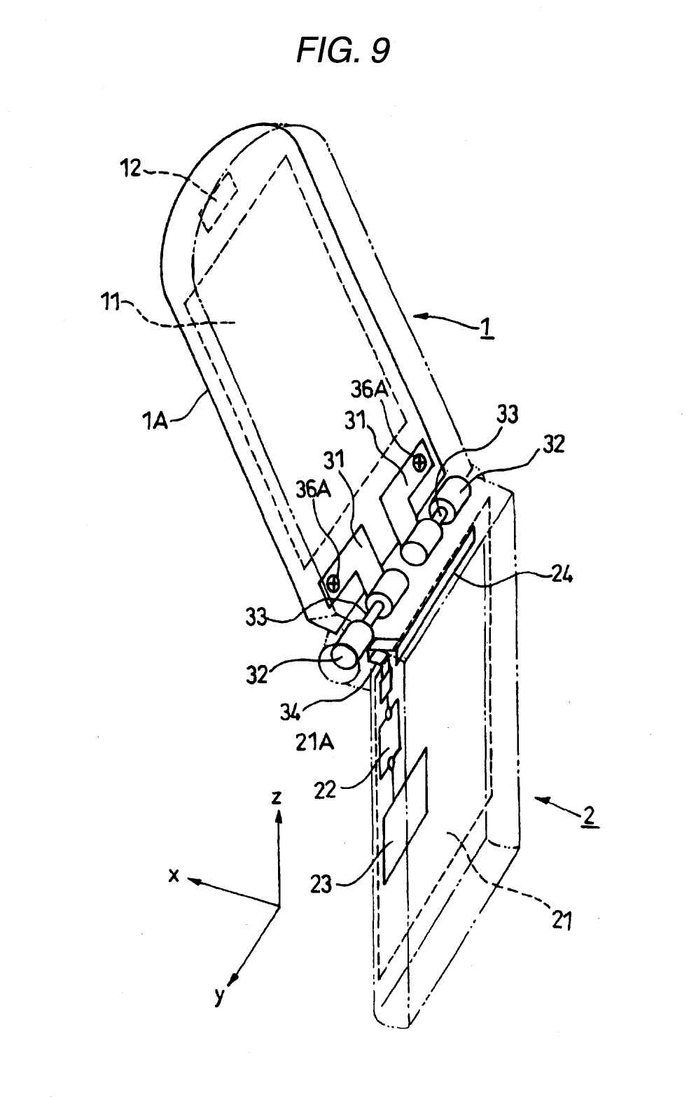

Further, in the present embodiment, the conductive metal element 35 is arranged to shunt the antenna-current of the feeding portion. But a conductive element 24 printed on the circuit board 21 may be employed, as shown in FIG. 9 (the same reference symbols as those in FIG. 1 indicate the same constituent elements). In that case, the number of articles can be reduced.

Further, in the present embodiment, the example in which the metal frame 1A arranged in the upper case 1A is used as the antenna element and the dipole antenna is constructed by the upper case 1A and the circuit board 21 arranged in the lower case 2 (the approach of reducing the local mean SAR) is shown. But an inverted F-type antenna, a helical antenna, a whip antenna, or the like, for example, maybe employed as the antenna arranged in the portable radio equipment. That is, it is important that the conductive metal element 35 should be connected to a portion in which the antenna current is concentrated.

### Second Embodiment

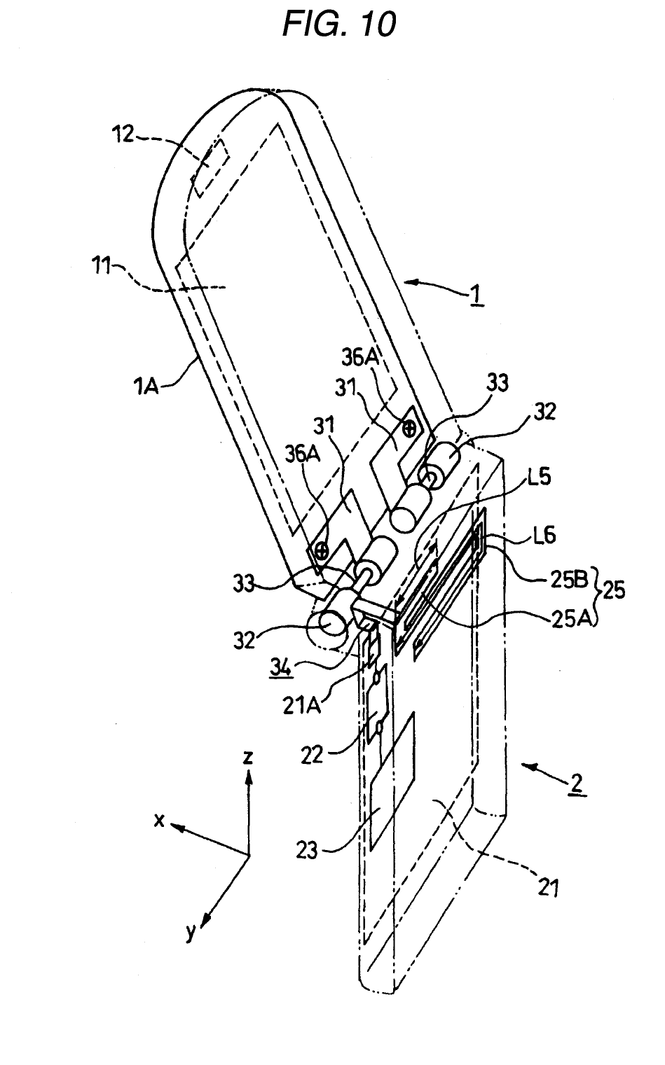

Next, a second embodiment of the present invention will be explained in detail with reference to FIG. 10 hereunder.

FIG. 10 is a perspective view showing a folding type portable radio equipment according to the present embodiment when viewed from the rear surface side. In this case, the same reference symbols as those in FIG. 1 show the same constituent elements and their detailed explanations will be omitted herein.

In the folding type portable radio equipment of the present embodiment, as shown in FIG. 10, a conductive metal element 25 connected electrically to the hinge portion 32 that acts as the feeding portion is constructed by two conductive metal elements having a different length respectively, i.e., a first conductive metal element 25A (length L5) and a second conductive metal element 25B (length L6).

The conductive metal element 25 is constructed integrally with the feeding metal 34, for example. In the present embodiment, the conductive metal element 25 is arranged on the lower case 2 near the surface opposing the surface on which the opening portion 12 for the earpiece portion is arranged on the upper case 1, i.e., on or near the surface on the (−) X direction side opposing the surface (X direction) on which normally the operation keys are arranged. Further, the first conductive metal element 25A and the second conductive metal element 25B constituting the above conductive metal element 25 are arranged perpendicularly to the long side (Z direction) of the lower case 2, i.e., in parallel with the Y direction. Their one ends are connected electrically to the second hinge portion 32, and the other ends are formed as an open end respectively.

An operation of the folding type portable radio equipment constructed as above will be explained hereunder. Here, explanation will be made under the assumption that an operating frequency of the antenna is set to two frequency bands of 0.83 GHz (wavelength about 361 mm) and 1.92 GHz (wavelength about 156 mm), for example.

The length L5 of the first conductive metal element 25A is about 38 mm (about ¼ wave of the wavelength corresponding to the frequency 1.92 GHz), for example. Further, the length L6 of the second conductive metal element 25 is about 90 mm (about ¼ wave of the wavelength corresponding to the frequency 0.83 GHz), for example.

For example, since the length L5 of the first conductive metal element 25A is about ¼ wave with respect to the wavelength when an operating frequency of the antenna is 1.92 GHz, the antenna current flowing through the first conductive metal element 25A is maximized. Therefore, as also explained in the first embodiment, the antenna current being concentrated in the second hinge portion 32 as the feeding portion of the dipole antenna is shunted in the first conductive metal element 25A.

In contrast, since the length L6 of the second conductive metal element 25B is about ¼ wave with respect to the wavelength when an operating frequency of the antenna is 0.83 GHz, the antenna current flowing through the second conductive metal element 25B is maximized. Therefore, similarly the antenna current being concentrated in the second hinge portion 32 as the feeding portion of the dipole antenna is shunted in the second conductive metal element 25B.

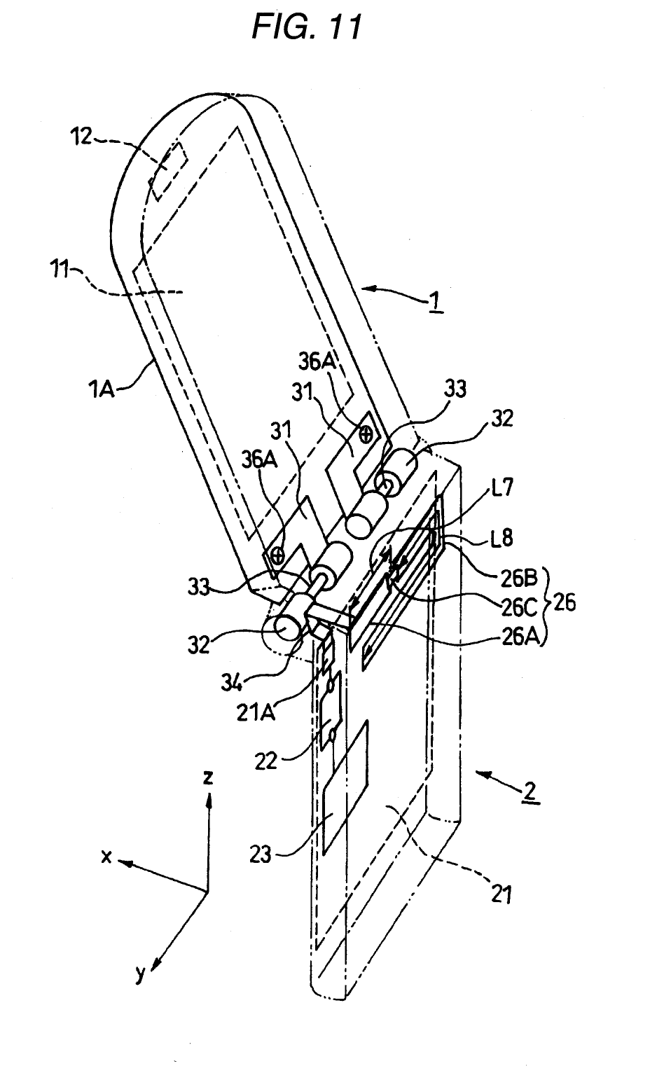

Further, in a folding type portable radio equipment shown in FIG. 11, a conductive metal element 26 connected electrically to the second hinge portion 32 acting as the feeding portion is constructed by two conductive metal elements that are connected via a resonance circuit 26C and have a different length respectively, i.e., a first conductive metal element 26A (length L7) and a second conductive metal element 26B (length L8). The conductive metal element 26 is constructed integrally with the feeding metal 34, for example. In the presents embodiment, like the folding type portable radio equipment shown in FIG. 10, the conductive metal element 26 is also arranged on the lower case 2 near the surface opposing the surface (inner surface) on which the opening portion 12 for the earpiece portion is arranged on the upper case 1, i.e., on or near the surface on the (−) X direction side opposing the surface (X direction) on which normally the operation keys are arranged. Further, like the folding type portable radio equipment shown in FIG. 10, the first conductive metal element 26A and the second conductive metal element 26B are arranged perpendicularly to the long side (Z direction) of the lower case 2, i.e., in parallel with the Y direction. Their one ends are connected electrically to the second hinge portion 32 and the other ends are formed as an open end respectively.

Further, in FIG. 11, the resonance circuit 26C is composed of an inductor 39 nH arranged in series with two conductive metal elements, for example. The resonance circuit 26C takes a through state in a high-frequency range based on its resonance characteristic when an operating frequency of the antenna is set to 0.83 GHz, and also takes an open state in a high-frequency range when an operating frequency of the antenna is set to 1.92 GHz.

Here, when an operating frequency of the antenna is set to 1.92 GHz, for example, only the first conductive metal element 26A is operated based on the resonance characteristic of the resonance circuit 26C. At this time, since the length L7 of the first conductive metal element 26A is about ¼ wave with respect to the wavelength, the antenna current flowing through the first conductive metal element 26A is maximized. Therefore, as also explained in the first embodiment, the antenna current being concentrated in the second hinge portion 32 as the feeding portion of the dipole antenna is shunted in the first conductive metal element 26A.

In contrast, when an operating frequency of the antenna is set to 0.83 GHz, the first conductive metal element 26A and the second conductive metal element 26B are operated based on the resonance characteristic of the resonance circuit 26C. At this time, the element length of the conductive metal element 26 is given by a total length (L7+L8) of the first conductive metal element 26A and the second conductive metal element 26B. Further, the resonance circuit 26C operates as an inductance, such circuit possesses the effect of extending an electric length. As a result, the electric length of the conductive metal element 26 becomes about ¼ wave with respect to the wavelength, and thus the antenna current flowing through the conductive metal element 26 is maximized. Therefore, as also explained in the first embodiment, the antenna current being concentrated in the second hinge portion 32 as the feeding portion of the dipole antenna is shunted in the conductive metal element 26.

In this manner, according to the folding type portable radio equipment of the second embodiment, the conductive metal element whose electric length becomes about ¼ wave at two desired frequencies is connected electrically to the feeding portion in which the antenna current is concentrated, and arranged perpendicularly to the long side (Z direction) of the lower case 2, i.e., in parallel with the Y-axis direction. Further, the end portion of the conductive metal element opposing to the end portion connected to the feeding portion is formed as the open end. Therefore, the antenna current can be shunted to the conductive metal element at two frequencies and the polarization can be optimized to the speaking condition. As a result, the local mean SAR can be reduced and also the high antenna gain can be ensured.

Now, the present invention is not restricted to the above embodiments at all, and can be carried out in various modes without departing from the gist of the present invention. For example, in FIG. 10, the first conductive metal element 25A and the second conductive metal element 25B may be arranged along a thickness direction of the case. Any arrangement may be employed if these elements have respective lengths corresponding to two frequencies. Further, in FIG. 11, the first conductive metal element 26A is explained as the element that corresponds to a higher frequency out of two different frequencies. But the first conductive metal element 26A may be provided as the element that corresponds to a lower frequency. Further, the number of different frequencies is not limited to two, and the conductive metal element 26 corresponding to tree frequencies or more may be employed. That is, the conductive metal element 26 may be constructed by the element having three different lengths or more.

This application is based upon Japanese Patent Application (Patent Application No. 2004-342418) filed on Nov. 26, 2004; the contents of which are incorporated herein by reference.

### INDUSTRIAL APPLICABILITY

The present invention possesses such an advantage that the high antenna performance can be ensured since the antenna current in the thin antenna built in the case can be distributed to a position that is away from the human body and also a polarization can be optimized to a speaking condition, and is useful to the folding type portable radio set, or the like.

1. A folding type portable radio equipment comprising:
a first case and a second case;
an antenna element provided to the first case;
a hinge portion for joining turnably the first case and the second case;
a circuit board provided in the second case and having a ground pattern thereon;
a feeding portion connected to a radio circuit on the circuit board; and
a conductive metal element arranged on the hinge portion and having a predetermined length;
wherein the hinge portion includes first and second hinge portions formed of a conductive metal, and a joining portion for connecting electrically the first hinge portion and the second hinge portion and supporting turnably the first hinge portion and the second hinge portion,
wherein the first hinge portion is provided to the first case and connected electrically to an end portion of the antenna element on a hinge portion side, and the second hinge portion is provided to the second case and is arranged at a predetermined interval from a ground pattern on the circuit board and connected electrically to the feeding portion,
wherein the conductive metal element is arranged to intersect orthogonally with a longitudinal direction of the second case such that one end thereof is connected electrically to the second hinge portion and the other end is opened, and
wherein the antenna element, and the hinge portion and the ground pattern on the circuit board are constructed to operate as a dipole antenna.

2. A folding type portable radio equipment according to claim 1, wherein the conductive metal element resonates at a particular frequency.

3. A folding type portable radio equipment according to claim 1, wherein the conductive metal element has a structure that resonates at two particular frequencies or more.

4. A folding type portable radio equipment according to claim 1, wherein the conductive metal element is printed on the circuit board provided in the second case.

5. A folding type portable radio equipment according to claim 1, wherein the conductive metal element is arranged on an opposite surface side to a surface on which operation keys are arranged in the second case.
